(19) United States
(12) Patent Application Publication
(10) Pub. No.: US 2015/0150011 A1
(43) Pub. Date: May 28, 2015

(54) Self-splitting of workload in parallel computation

(71) Applicants: Matteo Fischetti, Padova (IT); Michele Monaci, San Lazzaro di Savea (IT); Domenico Salvagnin, Legnaro (IT)

(72) Inventors: Matteo Fischetti, Padova (IT); Michele Monaci, San Lazzaro di Savea (IT); Domenico Salvagnin, Legnaro (IT)

(73) Assignee: UNIVERSITA DEGLI STUDI DI PADOVA, Padova (IT)

(21) Appl. No.: 14/087,136

(22) Filed: Nov. 22, 2013

(51) Int. Cl. G06F 9/48

(52) U.S. Cl. CPC G06F 9/48
USPC 718/102

(57) ABSTRACT

In a method for distributing execution of a problem to a plurality of K (wherein K≧2) workers, a pair of identifiers (k, K) is transmitted to each worker, wherein k uniquely identifies each worker and wherein K indicates the total number of workers. Each worker applies a first rule deterministically and autonomously without communicating between the workers. The first rule is the same for each worker. The first rule splits the problem in m parts, wherein m≧K. Each worker applies a second rule deterministically and autonomously without communicating between the workers. The second rule assigns each of the m parts to one of the K workers. The second rule is the same for each worker. Each worker processes exactly the parts that have been assigned thereto, thereby generating a unit of output. Each of the units of output from each worker is merged.

### BACKGROUND OF THE INVENTION

1. Field of the Invention

The present invention relates to computational systems and, more specifically, to a system for automatic partitioning in a parallel/distributed computational environment.

2. Description of the Related Art

Parallel computation requires splitting a job among a set of processing units called “workers.” The computation is generally performed by a set of one or more master workers that split the workload into chunks and distribute them to a set of slave workers; master and slave workers can coincide in some implementations or variants. To guarantee correctness and achieve a desirable balancing of the split (needed for scalability), many schemes introduce a large overhead due to the need of heavy communication and synchronization among the involved workers.

In a typical parallel system, a certain number of different workers are available to perform a certain job. The workers are typically located on different physical computers. Thus, some overhead is typically incurred when communication among the workers is required. Similar conditions arise when workers are associated to different cores on the same computer and/or nodes in a computer network.

Parallel computation requires splitting a job among a set of workers. In a commonly-used parallelization paradigm referred to as “MapReduce,” the overall computation is organized in two steps and performed by two user-supplied operators, namely, map( ) and reduce( ). The MapReduce framework is in charge of splitting the input data and dispatching it to an appropriate number of mappers, and also of the shuffling and sorting necessary to distribute the intermediate results to the appropriate reducers. The output of all reducers is finally merged. This scheme may be suited for applications with a very large input that can be processed in parallel by a large number of mappers, while producing a manageable number of intermediate parts to be shuffled. However, the scheme may introduce a large overhead due to the need of heavy communication and synchronization between the map and reduce phases.

In a different approach, based on the concept of work-stealing, the workload is initially distributed to the available workers. If the splitting turns out to be unbalanced, the workers that have already finished their processing “steals” part of the work from the busy ones. The process is periodically repeated in order to achieve a proper load balancing. This approach can require a significant amount of communication and synchronization among the workers.

One scenario for parallel processing is that of Mixed Integer Programming (MIP), a paradigm for modeling and solving a variety of practical optimization problems. Generally, a mixed integer program is an optimization problem of the form:
minimize f(x)
subject to G(x)≦0
l≦x≦u
some or all xj integral,
   where x is a vector of variables, l and u are vectors of bounds, f(x) is the objective function, and G(x)≦0 is a set of constraints. Similar models with maximization objective and/or involving equality constraints belong to the MIP class as well. In addition, Mixed-Integer Linear Programming arises as a special case of MIP when f and G are linear (or affine) functions.

A standard technique for solving MIP problems is a version of divide-and-conquer known as branch-and-bound, or implicit enumeration. Assume that a feasible “incumbent” solution of the problem with objective value U is known. The value U is usually referred to as “primal bound” and may initially be set to a very large number if no feasible solution is known. The branch-and-bound algorithm begins by solving a relaxation of the problem, obtained, for example, by deleting the integrality restrictions. If the relaxation is found to be infeasible, then the original problem is also infeasible and the algorithm terminates. On the other hand, if the solution of the relaxation satisfies all the constraints of the original problem, then this solution is optimal for the original problem as well, and the algorithm terminates. If none of the two conditions apply, the problem solution space is partitioned into two or more pieces (this step is called branching), and the method is applied recursively to the subproblems thus obtained. The whole mechanism is typically visualized by a tree (called enumeration tree, or branch-and-bound tree, or search tree, or alike) in which nodes correspond to (sub)problems and arcs to branchings. In a standard branch-and-bound implementation, all tree nodes that have been created but are not yet processed are kept in a queue Q. Every time a node is been processed, another node is picked from Q according to some specific policy, and the process continues. The algorithm ends when Q is empty. Given an arbitrary node n, the basic processing involves solving a relaxation of the subproblem associated with n. Then four conditions apply:
1. If the relaxation is infeasible, the subproblem is infeasible as well, and the node can be pruned.
2. If the optimal value of the relaxation (known also as dual bound of the subproblem) is no smaller than the primal bound, then no improving solution can be found in this subproblem, and the node is pruned as well (bounding step).
3. If the optimal solution of the relaxation satisfies all the constraints of the original problem, then this is an optimal solution of the subproblem, and can be used to update the incumbent (the value U is updated accordingly).
4. If none of the above applies, then the subproblem is split again and the child nodes corresponding to the new subproblems are put into Q.

While this is a legitimate description of the basic concepts of branch-and-bound algorithms, different and more sophisticated branch-and-bound implementations are possible (and usually implemented), without changing the rationale of the method.

A similar algorithm is used also in Constraint Programming (CP), where however no explicit dual bound is computed at each node. In the CP paradigm, there is typically no objective function and the problem is determining a feasible solution or proving that no vector x such that G(x)≦0 exists in the domain of the variables, defined by vectors l and u. Branching is imposed by splitting the domain of a given variable so as to reduce the variable domains in the subproblems. In addition, propagation techniques are used to possibly reduce the domain of the other variables. A node is pruned when the domain of some variables is empty, which means that no feasible solution can exist for the current node.

A heuristic (as opposed to exact) solution method does not guarantee the finding of a correct answer (e.g., an optimal/feasible solution for an NP-hard problem), but is fast enough to become attractive in practical contexts. Local search heuristics are able to quickly explore small parts of the solution space, and can be embedded in meta-schemes such as Tabu Search. Parallelization of a given heuristic can easily be obtained by using a multi-start strategy that essentially consists in applying the same local search method to explore random (possibly overlapping) parts of the solutions space.

The schemes described above may be particularly suited for being applied in a parallel fashion, as different nodes can be processed by different workers concurrently. However, traditional schemes require an elaborate load balancing strategy, in which the set of nodes in Q is periodically distributed among the workers. Depending on the implementation, this may yield a deterministic or a nondeterministic algorithm, with the deterministic option being in general less efficient because of synchronization overhead. In any case, a non-negligible amount of communication is needed among the workers.

Therefore, there is a need for a simple “self-splitting” mechanism to overcome the issues of the approach above.

There is also a need for a system in which each worker is able to autonomously determine, without any communication with the other workers, the job parts it has to process.

There is also a need for a method for solving a problem in a parallel/distributed environment, without an explicit master-slave decomposition scheme, e.g. a scheme where one or more master workers determine and distribute the workload to slave workers.

There is also a need for a parallel/distributed algorithm, which is deterministic and almost communication-free.

### SUMMARY OF THE INVENTION

The disadvantages of the prior art are overcome by the present invention which, in one aspect, is a method, operable on a digital computer, for distributing execution of a problem to a plurality of K (wherein K≧2) workers, in which a pair of identifiers (k, K) is transmitted to each worker, wherein k uniquely identifies each worker and wherein K indicates the total number of workers. Each worker applies a first rule deterministically and autonomously without communicating between the workers. The first rule is the same for each worker. The first rule splits the problem in m parts, wherein m≧K. Each worker applies a second rule deterministically and autonomously without communicating between the workers. The second rule assigns each of the m parts to one of the K workers. The second rule is the same for each worker. Each worker processes exactly the parts that have been assigned thereto, thereby generating a unit of output. Each of the units of output from each worker is merged.

In another aspect, the invention is a computational system for distributing execution of a problem to a plurality of K (wherein K≧2) workers, that includes a processing environment and a tangible computer readable memory that stores a series of instructions configured to cause the processing environment to execute a plurality of steps. Through the plurality of steps, a pair of identifiers (k, K) is transmitted to each worker, wherein k uniquely identifies each worker and wherein K indicates the total number of workers. Each worker applies a first rule deterministically and autonomously without communicating between the workers. The first rule is the same for each worker. The first rule splits the problem in m parts, wherein m≧K. Each worker applies a second rule deterministically and autonomously without communicating between the workers. The second rule assigns each of the m parts to one of the K workers. The second rule is the same for each worker. Each worker processes exactly the parts that have been assigned thereto, thereby generating a unit of output. Each of the units of output from each worker is merged.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram illustrating a generic framework of a self-splitting method.

FIG. 2 is a flowchart showing a simple embodiment of the self-splitting method as executed by a given worker, when applied to a branch-and-bound algorithm for optimization problems.

FIG. 3 is a flowchart showing a somewhat elaborate embodiment of the self-splitting method as executed by a given worker, when applied to a branch-and-bound algorithm for optimization problems.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

The present invention employs a “self-splitting” mechanism to split a given job among workers, with almost no communication among the workers. With this approach: (i) each worker works on the whole input data and is able to autonomously decide the parts it has to process; (ii) almost no communication between the workers is required; and (iii) the resulting algorithm can be implemented to be deterministic. The above features make the invention very well suited for those applications in which encoding the input and the output of the problem requires a reasonably small amount of data (i.e., it can be stored within a single worker), whereas the execution of the job can produce a very large number of time-consuming job parts. This is typical, e.g., when using some enumerative/tree-search method to solve an NP-hard problem, i.e., a problem for which each known solution method requires processing of a number of parts that grows exponentially with the input size in the worst case. As such, the present invention is well suited for (but not limited to) high performance computing (HPC) applications.

The present invention generally encompasses a software program operating on a computational environment (as defined herein, a computational environment can include a computer, a general-purpose microprocessor, a cluster of computers, two or more cores, a computational grid, a computational cloud, a set of mobile terminals, other computational devices and combinations thereof) that implements the self-splitting algorithm. The self-splitting scheme addresses the parallelization of a given deterministic algorithm, function or method, called “the original algorithm” in what follows, that solves a job/problem by breaking it into parts/subjobs/subproblems (each part will be called “a node” in what follows).

In one simple representative implementation, the invention employs an algorithm as follows:
1. Two integer (or other type of identifier) parameters (k, K) are added to the original input: K denotes the number of workers, while k is an index that uniquely identifies the current worker (1<=k<=K).
2. There is a global flag ON_SAMPLING that is initialized to TRUE, that becomes FALSE when a given condition is met, such as the branch-and-bound queue Q contains a sufficiently large number of open nodes, or similar. When the flag ON_SAMPLING is set to FALSE we say that the “sampling phase” is over.
3. Each time a node n is created, it is deterministically assigned a color c(n), (1<=c(n)<=K), where c(n) is a pseudo-random integer in the interval [1,K] if ON_SAMPLING=TRUE, and k otherwise.
4. Whenever the modified algorithm is about to process a node n, the condition NODE_KILL(n)=(NOT ON_SAMPLING) AND (c(n)≠k) is evaluated.
   a. if NODE_KILL(n) is TRUE, node n is just discarded, as it corresponds to a subproblem assigned to a different worker;
   b. if NODE_KILL(n) is FALSE, the processing of node n continues as usual and no modified action takes place.

Each worker executes exactly the same algorithm, but receives a different input value for k. The above method ensures that each worker can autonomously and deterministically identify and skip the nodes that will be processed by other workers, and no node is left uncovered by all workers. The above algorithm is straightforward to implement if the original deterministic algorithm is sequential, and the random/hash function used to color a node is deterministic and identical for all workers. The algorithm can be easily applied also if the original algorithm is itself parallel, provided that the pseudo-random coloring at step 3 is done right after a synchronization point.

When all workers terminate the execution of the modified algorithm, their output is collected, e.g., by sending it to a specific processing unit (say that with k=1) that will merge them and provide the final output. A more sophisticated tree-like scheme for output merging is also possible. The final merging phase requires a certain (unavoidable) amount of communication among workers, but it is assumed that output merging is not a bottleneck of the overall computation. For example, in the case of branch-and-bound or tree search, only the best solution found by each worker needs to be communicated.

Load balancing is automatically obtained by the modified algorithm in a statistical sense: if the condition that triggers the end of the sampling phase is appropriately chosen, then the number of subproblems to distribute is significantly larger than the number of workers K, and thus it is unlikely than a given worker will be assigned much more work than any other worker.

A more elaborate version, aimed at improving workload balancing among workers even more, can be devised using an auxiliary queue S of “paused nodes.” Such a modified algorithm reads as follows:
1. Two integer (or other type of identifier) parameters (k, K) are added to the original input: K denotes the number of workers, while k is an index that uniquely identifies the current worker (1<=k<=K).
2. Queue S is initialized to empty.
3. Whenever the modified algorithm is about to process a node n, a procedure NODE_PAUSE(n) is called:
   a. if NODE_PAUSE(n) is TRUE, node n is moved into S and the next node is considered;
   b. if NODE_PAUSE(n) is FALSE, the processing of node n continues as usual and no modified action takes place.
4. When there are no nodes left to process, the “sampling phase” ends. All nodes in S, if any, are popped out and assigned an integer “color” c (1<=c<=K), according to a deterministic rule.
5. All nodes whose color c is different from the current input parameter k are just discarded. The remaining nodes are processed (in any order) till completion.

Because it has access to all the nodes in S, the coloring phase at Step 4 has more chances to determine an even workload split among the workers than the first variant, at the expense of a slightly more elaborate implementation.

Another relevant application of the invention arises in the context of heuristic methods, e.g. in optimization, where a self-splitting variant allows each worker to explore (either exactly or heuristically) non-overlapping parts of the solution space, even if the union of those parts does not necessarily cover the solution space entirely.

The invention can also be used to obtain a lower bound on the amount of computing time needed to solve the problem with K workers, as well as to quickly compute an estimate of the amount of computing time needed to solve the problem with the original (unmodified) algorithm by a single worker.

Another application of the invention is to split the overall workload into K chunks to be solved independently at different points in time. In this way one can implement a simple strategy to pause and resume the overall computation even on a single (or few) worker(s). This is also beneficial in case of failures, as it allows one to re-execute the affected chunks only.

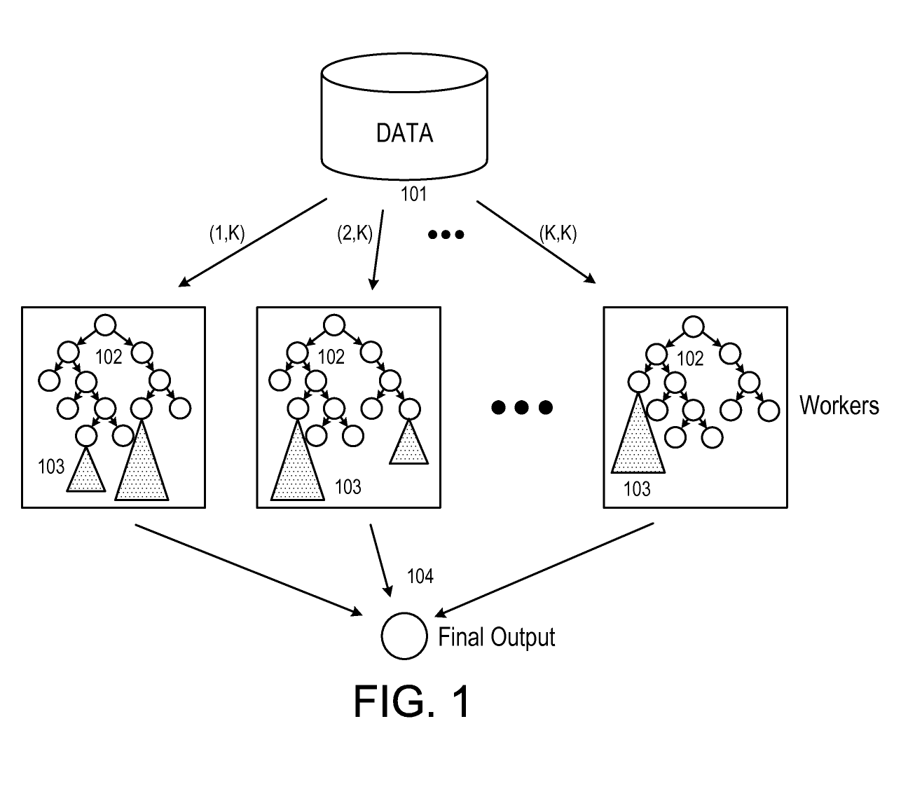

As shown in FIG. 1, in one representative embodiment of a generic framework of the self-splitting method, each worker reads 101 the original input data and receives the pair (k,K) that identifies it. The input is assumed to be of manageable size, so no parallelization is needed at this stage. The same computation is performed 102, in parallel, by all workers. This sampling phase is illustrated in the figure by the fact that exactly the same enumeration tree is built by all workers. No communication at all is involved in this stage. It is assumed that the sampling phase is not a bottleneck in the overall computation, so the fact that all workers perform redundant work introduces an acceptable overhead.

When the sampling phase ends 103, each worker has enough information to identify and solve the parts that belong to it (shown as gray subtrees in the figure), without any redundancy. No communication among workers is involved in this stage. It is assumed that processing the subtrees is the most time-consuming part of the algorithm, so the fact that all workers perform non-overlapping work is instrumental for the effectiveness of the self-splitting method.

When a worker ends its own job 104, it communicates its final output to a merger worker that process it as soon as it receives it. The merger worker can in fact be one of the K workers, for example worker 1, that merges the output of the other workers after having completed its own job.

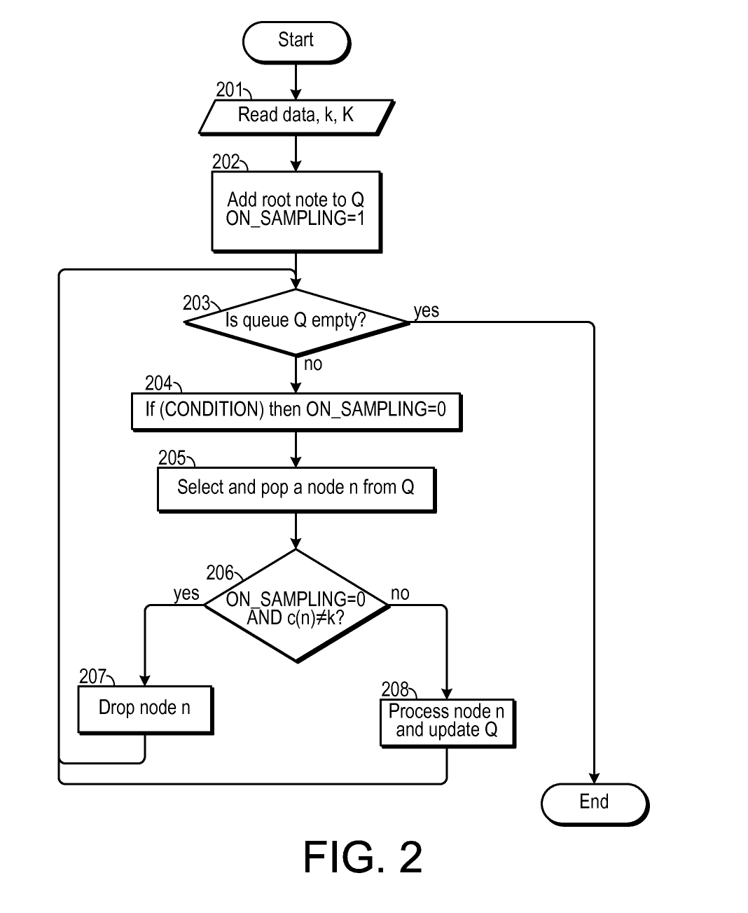

FIG. 2 illustrates a basic (or “vanilla”) implementation of the self-splitting method as executed by a given worker when applied to a branch-and-bound algorithm for optimization problems. Each worker reads the original input data and receives the pair (k,K) that identifies it 201. Again, the input is assumed to be of manageable size, so no parallelization is needed at this stage. The ON_SAMPLING flag is set to TRUE, and the root node of the search tree, corresponding to the whole problem, is added to Q 202. The node-processing loop starts. If queue Q is empty, then the current worker has finished its part of the job and the process ends 203. If not, the algorithm continues to step 204. The condition controlling the ON_SAMPLING flag is checked and, if the condition is met, the ON_SAMPLING is set to FALSE and the sampling phase is over 204. Given that queue Q is not empty, a node n is selected and popped from the queue for processing 205. If the sampling phase is over (ON_SAMPLING is FALSE) and the color c(n) of the current node n is different from the integer k 206, then the node n is dropped without any further processing (step 207) and the algorithm then moves back to step 203. If condition 206 is not met, either because we are still in the sampling phase or because the node n has color c(n) equal to k, the usual processing of the node is performed, as described in the previous section 208. If the subproblem corresponding to node n is not solved, then branching occurs and the new nodes are added to the queue Q. The new nodes are also assigned a deterministic color c in this step. After updating the queue Q, the algorithm moves back to step 203.

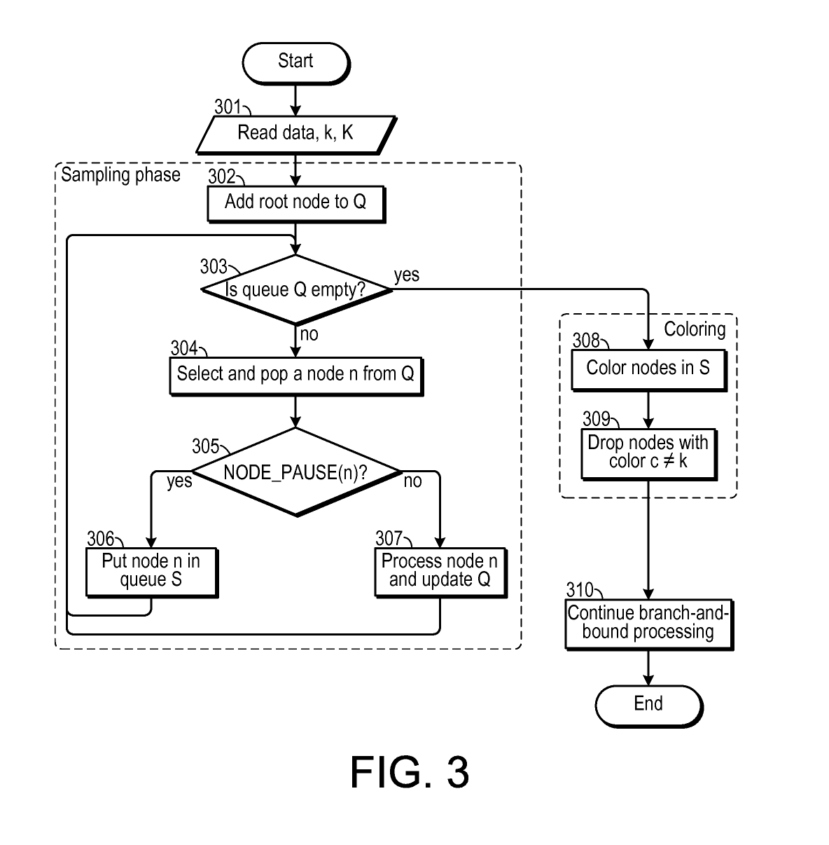

FIG. 3 illustrates a more elaborate implementation of the self-splitting method as executed by a given worker, when applied to a branch-and-bound algorithm for optimization problems. Each worker reads the original input data and receives the pair (k,K) that identifies it 301. Again, the input is assumed to be of manageable size, so no parallelization is needed at this stage. The root node of the search tree, corresponding to the whole problem, is added to Q 302. The node-processing loop starts. If queue Q is empty 303, then the sampling phase is over and the algorithm continues to step 308. If queue Q is not empty, a node n is selected and popped from the queue for processing 304. The procedure NODE_PAUSE(n) is called 305. If its outcome is TRUE, then processing of node n is delayed, and node n itself is put into the special queue S (step 306). The algorithm then moves back to step 303. If the outcome of NODE_PAUSE(n) 305 is FALSE, then node n is processed as usual, and queue Q is possibly updated in case branching occurs 307. After updating the queue Q, the algorithm moves back to step 303. After the sampling phase is over, all nodes in S are colored according to a deterministic rule, identical for all workers 308. All nodes in S whose color c is different from k are dropped forever by the current worker 309. The standard branch-and-bound loop continues starting from the surviving nodes (those with color c equal to k) 310, until completion.

One embodiment of the invention that refers to an enumerative method for optimization problems, and makes use of the queue S of paused nodes will now be described. In this implementation, both the decision of moving a node into S as well as the color actually assigned to a node are based on an estimate of the computational difficulty of the piece of work corresponding to node n.

To be specific, during the sampling phase a node is moved into S if its estimated difficulty is significantly smaller than the one associated to the root node. The estimate is obtained by computing the cardinality of the Cartesian product of the current domains of (some of) the variables, and comparing this value (or some related function, such as its logarithm) to the same measure as obtained at the end of the root node. Similar conditions could be defined that are based on different characteristics of the current subproblem, such as dual bound value in branch-and-bound methods, number of binary variables fixed to zero and/or one, etc.

As far as the coloring of the nodes in S is concerned, the color c to be associated with the nodes in queue S is obtained by computing a “score” based on the dual bound of the subproblem rooted at n and on the same measure (e.g., based on current domains of the variables) used for deciding whether to move a node into S or to process it, appropriately weighed. All nodes in S are ranked according to the computed score, and then assigned a color c between 1 and K, in round-robin, so as to split node scores evenly among workers. However, different scores could be defined, based on different characteristics of the current subproblem, and leading to a different ranking of the nodes. Alternatively, even a pseudo-random or hash-based coloring is allowed, provided that all workers use the same seed for the random engine or the same hash function, so as to guarantee that they all produce exactly the same coloring of the nodes.

In one representative embodiment of the invention, an adaptive scheme is used in order to avoid a too small set of nodes in S at the end of the sampling phase (a similar reasoning applies to the vanilla implementation as well). In particular, if the number of nodes in S is too small compared to K, then the internal parameters of the procedure NODE_PAUSE( ) are updated in order to make the move into the queue S less likely, and the sampling procedure is continued (after putting the nodes in S back into Q) or restarted. However, different strategies could be used as well to achieve the above goal. In addition, even a fixed strategy can be employed, provided that internal parameters of the procedure NODE_PAUSE( ) can be adjusted by an expert user/modeler (who may have additional knowledge on the instance at hand) at the beginning of the whole procedure.

The following changes and modifications can be made without departing from the scope invention:
a. The modified algorithm can be run with just K′<<K workers, with the input pairs (1,K), (2,K), . . . , (K′,K). In this case the overall procedure is heuristic in nature, meaning that some nodes will not be explored by any worker (namely, those with color k=K′+1, . . . , K). This setting is particularly attractive for the parallelization of heuristics for optimization/feasibility problem, as it ensures that the solution spaces explored (exactly or heuristically) by the K′ workers is non-overlapping—though their union does not necessarily cover the whole solution space.
b. The setting addressed in the previous item (namely, running just K′<<K workers) can also be used to obtain a lower bound on the amount of computing time needed to solve the problem with K workers (just take the maximum computing time among the K′ workers) as well as an estimate of the amount of computing time needed to solve the problem with the original (unmodified) algorithm by a single worker (e.g., through the simple formula estimated_total_time=sampling_time+K*average_time_spent_by_a_worker_after_sampling).
c. A limited amount of communication may be introduced between the workers after the sampling and coloring phases. This information is meant to exchange globally valid information, such as the primal bound in an enumerative scheme, which can be used to avoid unnecessary work by the workers.
d. All workers are allowed to (periodically) communicate, in order to ease the interaction with the user and/or to deal with failures in the computational environment. At the same time, one or more workers are allowed to communicate with other workers, and interrupt their work if necessary. For example, if a feasibility problem is addressed, as soon as a worker finds the first feasible solution, all the other workers can be interrupted as the overall problem is solved.
e. After sampling, each worker can decide not to discard the nodes that have two or more colors c1, c2, . . . , cm, where c1=k and the other colors c2, . . . , cm are selected randomly or according to some rules. In this case some redundant work is performed by the workers, e.g., with the aim of coping with failures in the computational environment. The final merger worker can stop the overall computation when all colors have been processed by some worker, even if other workers are still running or were aborted for whatever reason. Alternatively, two or more workers with the same index k can be run, in parallel, making the event that all of them fail very unlikely, and still keeping the communication overhead negligible, even in the final merge.
f. The invention can also be used to split the overall workload into K chunks to be solved independently at different points in time, thus implementing a simple strategy to pause and resume the overall computation even on a single (or few) worker(s). This is also beneficial in case of failures, as it allows one to re-execute the affected chunks only.

The above-discussed features make the present invention very well suited for those applications where communication among workers is time consuming, or expensive, or unreliable. In particular, the invention allows for a simple yet effective parallelization of divide-and-conquer algorithms with a short input that produce a very large number of time-consuming job parts, as it happens, e.g., when an NP-hard problem is solved by an enumerative/tree-search method such as branch-and-bound. If properly implemented, the resulting method is deterministic, and guarantees correct answers, meaning that no job part is left uncovered by the workers.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method, operable on a digital computer, for distributing execution of a problem to a plurality of K (wherein K≧2) workers, comprising the following steps:
(a) transmitting to each worker a pair of identifiers (k, K), wherein k uniquely identifies each worker and wherein K indicates the total number of workers;
(b) causing each worker to apply a first rule deterministically and autonomously without communicating between the workers, the first rule being the same for each worker, wherein the first rule splits the problem in m parts, wherein m≧K;
(c) causing each worker to apply a second rule deterministically and autonomously without communicating between the workers, wherein the second rule assigns each of the m parts to one of the K workers;
(d) causing each worker to process exactly the parts that have been assigned thereto, thereby generating a unit of output; and
(e) merging each of the units of output from each worker.

2. The method of claim 1, wherein the step in which the second rule assigns each of the m parts to one of the K workers is performed concurrently with the steps in which the first rule splits the problem in m parts.

3. The method of claim 1, wherein the step in which the second rule assigns each of the m parts to one of the K workers is selectively postponed after a “sampling phase” and is based on an estimate of computational difficulty associated with each part.

4. The method of claim 1, wherein the step in which the second rule assigns each of the m parts to one of the K workers is performed pseudo-randomly.

5. The method of claim 1, wherein only K′<K workers are invoked with the input pairs (1,K), (2,K), . . . , (K′,K), thus obtaining a heuristic method.

6. The method of claim 5, used to estimate the computational resources needed to solve the problem with any number of workers.

7. The method of claim 1, wherein communication between workers is allowed after a “sampling phase,” in order to ease the interaction with the user and/or to deal with failures in the computational environment.

8. The method of claim 1, wherein each worker makes redundant work by also processing all the parts assigned to one or more other workers, so as to cope with failures in the computational environment, while still keeping the communication overhead negligible, even in the final merge.

9. The method of claim 1, wherein input pairs (1,K), (2,K), . . . , (K,K) are processed sequentially by a single worker, thereby implementing a simple strategy to pause and resume computation in a safe way.

10. The method of claim 1, wherein input pair (k,K) is processed in parallel by two or more workers by running concurrent algorithms after a sampling phase.

11. A computational system for distributing execution of a problem to a plurality of K (wherein K≧2) workers, comprising:
(a) a processing environment; and
(b) a tangible computer readable memory that stores a series of instructions configured to cause the processing environment to execute the following steps:
(i) transmit to each worker a pair of identifiers (k, K), wherein k uniquely identifies each worker and wherein K indicates the total number of workers;
(ii) cause each worker to apply a first rule deterministically and autonomously without communicating between the workers, the first rule being the same for each worker, wherein the first rule splits the problem in m parts, wherein m≧K;
(iii) cause each worker to apply a second rule deterministically and autonomously without communicating between the workers, wherein the second rule assigns each of the m parts to one of the K workers;
(iv) cause each worker to process exactly the parts that have been assigned thereto, thereby generating a unit of output; and
(v) merge each of the units of output from each worker.

12. The computational system of claim 11, wherein the step in which the second rule assigns each of the m parts to one of the K workers is performed concurrently with the steps in which the first rule splits the problem in m parts.

13. The computational system of claim 11, wherein the step in which the second rule assigns each of the m parts to one of the K workers is selectively postponed after a “sampling phase” and is based on an estimate of computational difficulty associated with each part.

14. The computational system of claim 11, wherein the step in which the second rule assigns each of the m parts to one of the K workers is performed pseudo-randomly.

15. The computational system of claim 11, wherein only K′<K workers are invoked with the input pairs (1,K), (2,K), . . . , (K′,K), thus obtaining a heuristic method.

16. The computational system of claim 15, used to estimate the computational resources needed to solve the problem with any number of workers.

17. The computational system of claim 11, wherein communication between workers is allowed after a “sampling phase,” in order to ease the interaction with the user and/or to deal with failures in the computational environment.

18. The computational system of claim 11, wherein each worker makes redundant work by also processing all the parts assigned to one or more other workers, so as to cope with failures in the computational environment, while still keeping the communication overhead negligible, even in the final merge.

19. The computational system of claim 11, wherein input pairs (1,K), (2,K), . . . , (K,K) are processed sequentially by a single worker, thereby implementing a simple strategy to pause and resume computation in a safe way.

20. The computational system of claim 11, wherein input pair (k,K) is processed in parallel by two or more workers by running concurrent algorithms after a sampling phase.
